(19) United States
(12) Patent Application Publication
(10) Pub. No.: US 2015/0369696 A1
(43) Pub. Date: Dec. 24, 2015

(54) DEVICE FOR MECHANICALLY TESTING A PINION BETWEEN AN INTERNAL TOOTHSET AND AN EXTERNAL TOOTHSET AND/OR BETWEEN TWO EXTERNAL TOOTHSETS AT AN ADJUSTABLE ANGLE

(71) Applicant: HISPANO SUIZA, Colombes (FR)

(72) Inventor: Nicolas Raymond Jacques POIRSON, Conflans Sainte Honorine (FR)

(73) Assignee: HISPANO SUIZA, COLOMBES (FR)

(21) Appl. No.: 14/765,939

(22) PCT Filed: Feb. 10, 2014
(86) PCT No.: PCT/FR2014/050246

§ 371 Date: Aug. 5, 2015

(30) Foreign Application Priority Data
Feb. 13, 2013 (FR) 13 51231

(51) Int. Cl. G01M 13/02

(52) U.S. Cl. CPC G01M 13/025

(57) ABSTRACT

Mechanical test device including: an internal gear with internal teeth, configured to engage a pinion to be tested, the axis of the gear being fixed relative to the axis of the pinion to be tested; an internal gear support on which the gear is installed, a central movement transmission element configured to have a rotation movement about an axis fixed relative to the axis of the provided; a pinion to drive the gear, configured to engage the teeth of the gear; a mobile support on which the gear drive pinion is fixed; a support for the pinion to be tested, fixed relative to the support; and-an apparatus for putting the mobile support in rotation about the axis of the gear while the assembly composed of the pinion to be tested the gear the central transmission element and the pinion driving the gear is put into movement.

### TECHNICAL FIELD

The invention relates to the general technical field of mechanical transmission test systems. More precisely, the invention belongs to the technical field of mechanical test devices of a pinion that engages with an internal toothset and an external toothset or, depending on the pinion being tested, between two external toothsets at an adjustable angle. The invention has a closed mechanical loop to apply loads to the pinions, this device also being known as a “back to back test bench”.

### STATE OF PRIOR ART

Mechanical properties of movement transmission elements particularly such as toothed wheels, worm screws, racks and pinions have to be tested to guarantee transmission of movement with minimum energy loss. These tests are done when the mechanical movement transmission element to be tested is engaging, either driving or driven, with at least one other mechanical movement transmission element so as to form a meshed gear system. In general, these mechanical tests consist of observing the response of the movement transmission element to be tested when different torque values are applied to it.

There are many test means capable of driving a pinion to be tested on a meshed gear system. In some cases, a torque may be applied to the pinion directly by the use of a brake or any other resistive system. Above a certain power, a device has to be used to create a torque in a closed mechanical loop. This is called a back-to-back loop. In particular, a torque may for example be applied to the back-to-back device by direct torsion of a shaft line or by translation of helical toothsets.

Applying a torque to a test device by direct torsion consists of applying a static torsion to the connection shaft present in the previously opened back-to-back loop before coupling so as to maintain this torsion. Applying a torque by direct torsion has the disadvantage that the torque applied to the pinion to be tested cannot be modulated during rotation of the different parts of the test bench with the pinion to be tested, nor can the system be started without applying a torque to a support of the movement transmission elements.

Applying torque to a test device by translation of helical toothsets forming part of the back-to-back loop enables start up at no load. However, with such a system configuration, it is impossible to apply a high torque to the pinion to be tested due to the sliding connection between the helical toothset shaft and the toothsets to be tested.

Consequently, there is a persistent need for a mechanical test device of a pinion to be tested, firstly capable of applying a high torque to the pinion to be tested, excluding considerations about the mechanical behaviour of the pinion to be tested, and secondly capable of starting the system without applying torque to a movement transmission element support.

### PRESENTATION OF THE INVENTION

The purpose of the invention is to solve problems encountered in solutions according to prior art. In particular, it aims at improving mechanical pinion test devices so that firstly they are capable of applying a high torque to the pinion to be tested, excluding considerations about the mechanical strength of the pinion to be tested, and secondly they are capable of starting the system with no torque applied to a movement transmission element support.

In this respect, the purpose of the invention is a mechanical test device of a pinion to be tested comprising:
an internal gear with internal teeth and configured to engage a pinion to be tested, the axis of the internal gear being fixed relative to the axis of the pinion to be tested,
an internal gear support on which the internal gear is placed,
a central movement transmission element configured to have a rotation movement about a fixed axis fixed relative to the axis of the internal gear provided with internal teeth,
a pinion to drive the internal gear, configured to engage the internal teeth of the internal gear,
a mobile support on which the internal gear drive pinion is fixed,
a support for the pinion to be tested, fixed relative to the internal gear support,
means for putting the mobile support in rotation about the axis of the internal gear, while the assembly composed of the pinion to be tested, the internal gear with its internal teeth, the central transmission element and the pinion driving the internal gear is put into movement.

Driving of the assembly is defined by starting movement of each element of the assembly. This can be done in the test device of the pinion to be tested independently of starting rotation of the mobile support, in other words particularly before, at the same time as, after or without starting rotation of the mobile support. The device can then be started with no torque applied to a movement transmission element support.

The device can also apply a high torque to the pinion to be tested when the mobile support has been inclined such that the internal gear drive pinion engages the internal teeth of the internal gear close to the pinion to be tested. In particular, the mobile support can be rotated such that the internal gear drive pinion moves along the internal gear towards the pinion to be tested or away from it. The main limit in rotating the mobile support is related to considerations about the mechanical behaviour of the pinion to be tested to which an increasingly high force is applied in this case.

In fact, the means for putting the mobile support in rotation about the internal gear axis are such that the value of the torque applied to the pinion to be tested can be modulated by rotating the mobile support about the axis of the internal gear when starting to drive the assembly.

The central transmission element is configured so as to engage the pinion to be tested during the mechanical test of the pinion to be tested. The central movement transmission element may be of different natures. For example, it may be a worm screw, a toothed wheel or a pinion, each in particular possibly having an axis parallel to the axis of the internal gear. Those skilled in the art will know how to choose an appropriate central movement transmission element and the position of its axis.

Preferably, the axis of the central movement transmission element is coincident with the axis of the internal gear. In this case, the central movement transmission element axis remains fixed. The device is thus even simpler. Furthermore, it is also easy to modulate the force applied to the pinion to be tested.

Optionally, the invention may comprise one or several of the following characteristics, possibly but not necessarily combined with each other:

The means for putting the mobile support in rotation may include at least one actuator. Mobile support rotating means comprising an actuator provide many potential stable positions, by moving the loading pinion tooth by tooth along the internal gear by actuating the actuator. An actuator thus makes it easy to modulate the torque applied to the pinion to be tested, when the assembly is being put into movement. Depending on the position and number of actuators rotating the mobile support, the main limit of the test device for the pinion to be tested on the maximum value of the torque to be applied on the pinion to be tested are values derived from mechanical strength considerations of the elements of the assembly consisting of the internal gear, the central movement transmission element, the pinion to be tested and the internal gear drive pinion.

The actuator preferably comprises a first and a second end, the first end connecting the actuator to a support fixed relative to the internal gear support and the second end connecting the actuator to the mobile support within a connection zone. There are at least two alternatives that can be envisaged for the position of the actuator.

A first alternative consists of the central movement transmission element being supported by the mobile support between the internal gear drive pinion and the connection zone.

In this alternative in which the connection zone is close to a distal end of the mobile support relative to the internal gear drive pinion, the actuator may act as a lever to rotate the internal gear drive pinion. It may then be possible to use a lower power actuator. This alternative also makes it possible to fix the actuator to the mobile support independently of the attachment of the internal gear drive pinion to the mobile support.

A second alternative consists of the internal gear drive pinion being supported on the mobile support between the central movement transmission element and the connection zone. Since the actuator works in compression instead of in elongation, when it starts rotating the mobile support such that the internal gear drive pinion moves along the internal gear closer and closer towards the pinion to be tested, a smaller actuator can be used in the second alternative.

According to this alternative, in a first case the connection zone may be located at the attachment zone of the internal gear drive pinion to the mobile support, for example at a shaft of the internal gear drive pinion. The test device can then be more compact.

In a second case, the actuator may be outside the periphery of the internal teeth of the internal gear. Since the mobile support then has a longer lever arm, the dimension of the actuator can be even smaller than in the first case.

Preferably, the means for putting the mobile support in rotation are configured to enable displacement of the internal gear drive pinion over a sufficient angular range at the end of the teeth of the outer internal gear so that the required meshing force can be reached.

A torque that can vary over a large amplitude can then be applied as the assembly is being put into movement. The large angular opening of the displacement of the internal gear drive pinion makes it possible to apply high torques on the pinion to be tested. It is preferable that the central movement transmission element should be a toothed wheel. The axis of the central transmission element is then preferably coincident with the axis of the internal gear. The device then has at least three toothed wheels during the mechanical test, namely the internal gear drive pinion, the pinion to be tested and the central movement transmission element. The mechanical test device has the advantage of having some symmetry due to the three toothed wheels, and being more compact, particularly by being thinner along the direction of the axis of the internal gear.

Preferably, the internal gear drive pinion is identical to the pinion to be tested. The drive pinion may be chosen particularly to have the same toothset and to be the same size, except for manufacturing errors. When the central movement transmission element is a toothed wheel, the drive pinion then meshes with the central movement transmission element.

In this case, it is also possible to mechanically test the central movement transmission element between two external toothsets at an adjustable angle. The central movement transmission element can then engage the pinion to be tested and the internal gear drive pinion. The angle formed by the pinion to be tested, the central movement transmission element and the internal gear drive pinion, is adjustable within the limit of mechanical strength of the different elements of the device. The device can then be driven so as to achieve an appropriate angle.

Although the central movement transmission element may have a variety of natures and may form any type of meshing with the pinion to be tested, the central movement transmission element and the pinion to be tested preferably form a parallel mesh. The device may be configured particularly such that the central movement transmission element and the pinion to be tested, the pinion to be tested and the internal gear, the internal gear and the internal gear drive pinion each form a parallel gear system, during the mechanical test. The device can thus be more compact and have better symmetry, particularly when the axis of the central transmission element is coincident with the axis of the internal gear. A higher torque can be applied to the pinion to be tested. The system may also be started more easily without applying a torque to a movement transmission support element.

The pinion to be tested may have any type of toothset, for example a helical toothset or a herringbone toothset or straight teeth. The toothsets of the central movement transmission element, the internal gear and consequently the internal gear drive pinion are configured as a function of the toothset of the pinion to be tested.

The assembly may be configured so that it can be driven by rotating a movement transmission element chosen from among the pinion to be tested, the central movement transmission element, the internal gear and the internal gear drive pinion. Starting movement of any element of the assembly by appropriate means will start movement of all elements in the assembly. Those skilled in the art will be familiar with appropriate means. For example, any means of applying a torque to one of the transmission elements may be used. Obviously, movement imposed on the assembly is still applied in the test device independently of the rotation movement of the mobile support.

Another purpose of the invention is a method for making a mechanical test of a pinion to be tested, using a test device of a pinion to be tested comprising at least:
a step in which the mobile support is rotated about the axis of the internal gear, step during which the assembly composed of the pinion to be tested, the internal gear with its internal teeth, the central movement transmission element and the internal gear drive pinion, is forced into movement.

### BRIEF DESCRIPTION OF THE DRAWINGS

This invention will be better understood after reading the description of example embodiments given purely for guidance and in no way limitative with reference to the appended drawings in which:

FIG. 1 shows a three-quarter front view of a mechanical test device of a pinion to be tested according to a preferred embodiment of the invention;

FIG. 2 is a front view of the mechanical test device of a pinion to be tested in FIG. 1 at rest;

FIG. 3 is a front view of the mechanical test device of a pinion to be tested in FIG. 1 in operation;

FIG. 4 is a front view of a second embodiment of the invention;

FIG. 5 is a front view of a third embodiment of the invention.

### DETAILED PRESENTATION OF PARTICULAR EMBODIMENTS

Identical, similar or equivalent parts of the different figures have the same numeric references to facilitate comparison between one figure and the others.

The different parts shown in the figures are not necessarily at the same scale, to make the figures more easily understood.

The different variants must be understood as not being exclusive of each other and they can be combined with each other.

Each figure shows a mechanical device 1 for testing a pinion 20 to be tested that engages at an angle of 180° with an internal toothset and an external toothset at the same time. Mechanically, it is important to make this distinction because the distribution of stresses is not the same on an internal toothset and on an external toothset. The test device 1 according to the invention is representative of meshing on the internal toothset 31 of a toothed internal gear 30.

The mechanical test device 1 of the pinion 20 to be tested comprises an internal gear 30 provided with internal teeth 31 with axis 32 placed on an internal gear support 33. The pinion 20 to be tested is placed on a support 23 of the pinion 20 to be tested that is fixed relative to the support of the internal gear 30. A central movement transmission element 40 supported by the mobile support 60 engages the pinion 20 to be tested during the mechanical test of the pinion 20 to be tested. The mobile support 60 supports the central movement transmission element 40 and a pinion 50 driving the internal gear 30. The pinion 50 driving the internal gear 30 is configured to mesh with the internal teeth 31 of the internal gear 30. Means 70 of starting rotation of the mobile support 60 pivot the pinion 50 driving the internal gear 30 about the axis 32 of the internal gear 30 when movement of each element of the assembly 2 formed by the pinion 20 to be tested, the internal gear 30, the central movement transmission element 40, the pinion 50 driving the internal gear 30 about their corresponding axis, is started.

The means 70 for putting the mobile support 60 in rotation comprise an actuator 71 comprising a first end 71a connected to a support 73 fixed relative to the support 33 of the internal gear 30 and a second end 71b connected to the mobile support 60 in a connection zone 60a of the mobile support 60. In practice, the second end 71b of the actuator 71 has an axis 72. For example, the second end 71b may be in the form of a ring. The actuator 71 is a linear actuator that may be of any type, for example manual, electrical, pneumatic or hydraulic. Any actuator adapted to the mechanical test device 1 and known to those skilled in the art may be used in the device 1.

The axis 72 of the second end 71b of the actuator 71 and the axis of the pinion 50 driving the internal gear 30 can be free to move during actuation of the means 70 for putting the mobile support 60 in rotation. The axis of rotation 22 of the pinion 20 to be tested is fixed relative to the axis of the internal gear 32. The rotation axis of the mobile support 60, the axis of the central movement transmission element 40 and the internal gear axis are coincident.

The rotation axis 22 of the pinion 20 to be tested and the rotation axis 52 of the pinion 50 driving the internal gear 30 are parallel to each other and are preferably parallel to the axis of the internal gear 32. In all embodiments shown in the figures, the axis of the internal gear 32, the axis 52 of the pinion 50 driving the internal gear 30 and the axis of the internal gear 32 are parallel at rest and remain parallel during the mechanical test of the pinion 20 to be tested, except for manufacturing errors.

In preferred embodiment variants not shown, the axis 22 of the support 23 of the pinion 20 to be tested and the axis 52 of the pinion 50 driving the internal gear 30 are not necessarily parallel to the axis 32 of the internal gear 30, for example in the case in which the central movement transmission element 40 and the pinion 20 to be tested form a skew gear system or to adjust the relative position of each axis.

The gear system formed by the pinion 20 to be tested and the central movement transmission element 40 may be of different natures depending on the pinion to be tested and particularly its toothset that may for example be straight or helical. The gear system formed by the pinion to be tested and the central movement transmission element 40 may in particular be straight or skew or even conical.

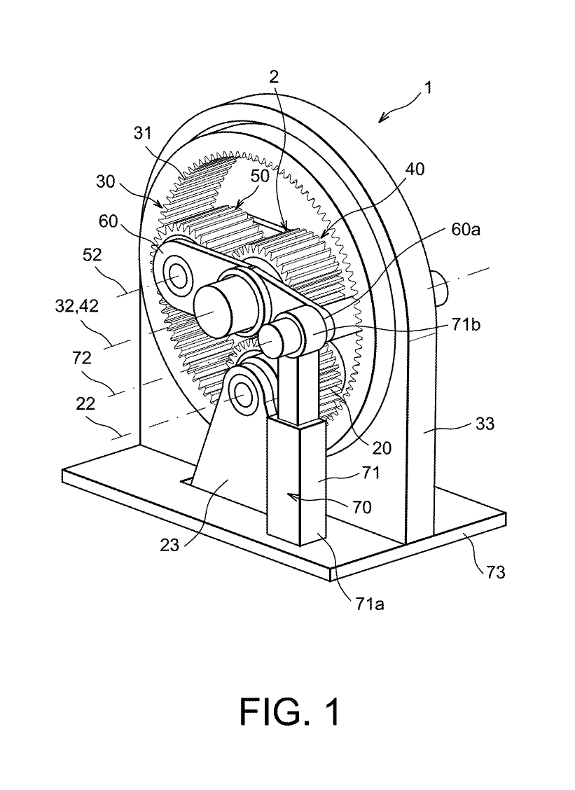

In the embodiments shown in FIGS. 1 to 5, the pinion 20 to be tested has a straight toothset. Furthermore the pinion 20 to be tested and the central transmission element 40, the internal gear 30 and the pinion 20 to be tested, the internal gear 30 and the pinion driving the internal gear each form a parallel gear system. Furthermore, since the pinion 50 driving the internal gear 30 is identical to the pinion 20 to be tested, the pinion driving the internal gear 50 meshes with the central movement transmission element 40 that is in the form of a toothed wheel, forming a parallel gear mesh. In this configuration, all gear meshes are parallel. The pinion 50 driving the internal gear 30 with the toothed internal gear, the pinion 50 driving the internal gear 30 with the central movement transmission element 40, the central movement transmission element 40 with the pinion 20 to be tested, the pinion 20 to be tested with the toothed internal gear form a closed loop parallel gear meshing train. This closed loop is called the back-to-back loop and has the advantage that it can apply a higher torque on the pinion 20 to be tested than is possible with an open system with a braking device using a translation system. In this configuration of embodiments in FIGS. 1 to 5, it is also possible to test the mechanical strength of the central movement transmission element 40, the central movement transmission element 40 meshing with two external toothsets forming a variable angle.

The toothsets of the toothed internal gear 30, the central movement transmission element 40 and the pinion 50 driving the internal gear 30 are configured to mesh with the toothset of the pinion 20 to be tested. In other words, the number of teeth, the shape of the teeth, the dimensions of the teeth in each toothset are configured as a function of the toothset of the pinion to be tested. The configuration of the toothsets of the different movement transmission elements 30, 40, 50 as a function of the configuration of the pinion 20 to be tested will be a simple matter for those skilled in the art. In all the figures, the pinion 20 to be tested has a straight toothset and the toothsets of the internal gear 30, the central movement transmission element 40 and the pinion 50 driving the internal gear 30 are all straight toothsets.

With reference to each figure, actuation of the actuator 71 of the means 70 for putting the mobile support 60 in rotation makes the mobile support 60 pivot about the axis 32 of the internal gear 30 independently of the movement of the assembly 2 and especially independently of the movement of the central movement transmission element 40, if any. As the mobile support 60 pivots, it provokes displacement of the axis 52 of the pinion 50 driving the internal gear 30 along the arc of a circle concentric with the internal gear. With reference specifically to FIG. 3, □ denotes the angle formed between the axis 52 of the pinion 50 driving the internal gear 30 and a line denoted the x axis, parallel to the base of the support 33 of the internal gear 30. The pinion 50 driving the internal gear moves along the internal gear meshing with the internal teeth 31 of the internal gear 30 between an angle □max and an angle □min corresponding to the extreme displacements of the actuator 71 along an axis perpendicular to the base of the support 33 of the internal gear 30. In other words, the means 70 for putting the mobile support 60 in rotation are configured to enable sufficient displacement of the pinion 50 driving the internal gear 30 over an angular opening at the end of the teeth of the outer internal gear to compensate for clearances, to compensate for deformation of the different elements and to reach the required gear meshing force. The position of the attachment 71a of the means 70 for putting the mobile support 60 in rotation, the attachment method 71a of the means 70 for putting the mobile support 60 in rotation and the movement distance of the rotation drive means 70 will be adapted to provide the necessary angular movement. Those skilled in the art will know how to choose this angular movement.

As the algebraic value of the angle □□ increases, in other words the further the pinion 50 driving the internal gear 30 moves away from the x axis, the higher will be the torque applied to the pinion to be tested. The main limit to displacement of the pinion 50 driving the internal gear 30 along the internal gear 30 towards the pinion to be tested, apart from limits due to the configuration of a particular actuator 71, is due to the mechanical strength of the central transmission element 40, the pinion 50 driving the internal gear 30, the internal gear 30 and especially the pinion 20 to be tested. The mechanical test of a pinion 20 to be tested according to the invention is preferably non-destructive but it could be envisaged that the pinion 50 driving the internal gear 30 could be inclined under the action of the means 70 for putting the mobile support 60 in rotation to cause damage to the pinion 20 to be tested.

During the mechanical test of a pinion 20 to be tested using the device 1 used in the embodiment in FIGS. 1 to 3, the mobile support 60 is rotated by the means 70 of rotating the mobile support until the pinion 50 driving the internal gear 30 is at the required inclination and applies the required value of torque to the pinion 20 to be tested, when each element starts rotating about its rotation axis in the assembly 2 formed by the pinion 20 to be tested, the internal gear 30, the pinion 50 driving the internal gear 30, and the central movement transmission element 40.

During the mechanical test process on the pinion 20 to be tested, the assembly 2 is made to move independently of the rotation of the mobile support 60 under the action of rotation drive means 70 of the mobile support 60. The assembly 2 is moved only by rotation of a movement transmission element 20, 40, 50 chosen from among the pinion 20 to be tested, the central movement transmission element 40 and the pinion driving the internal gear 50. Like the pinion 20 to be tested, the central movement transmission element 40 and the pinion driving the internal gear 50 drive each other through the internal gear 30, all that is necessary is to rotate one of the movement transmission elements and all the others will start rotating about their axes. An auxiliary device (not shown) to apply a torque to any single one of these elements may be provided to put the assembly 2 into movement.

In the embodiment shown in FIGS. 1 to 3, the central movement transmission element 40 is supported on the mobile support 60 between the pinion 50 driving the internal gear 30 and the connection zone 60a of the second end 71b of the actuator. The central movement transmission element 40 can thus be supported through the axis 42 independently of the support means 60, for example by means of a frame connected to the fixed support 73. The support means 60 could then be supported by the axis 42, or it could be supported by a support means connected to the fixed support 73.

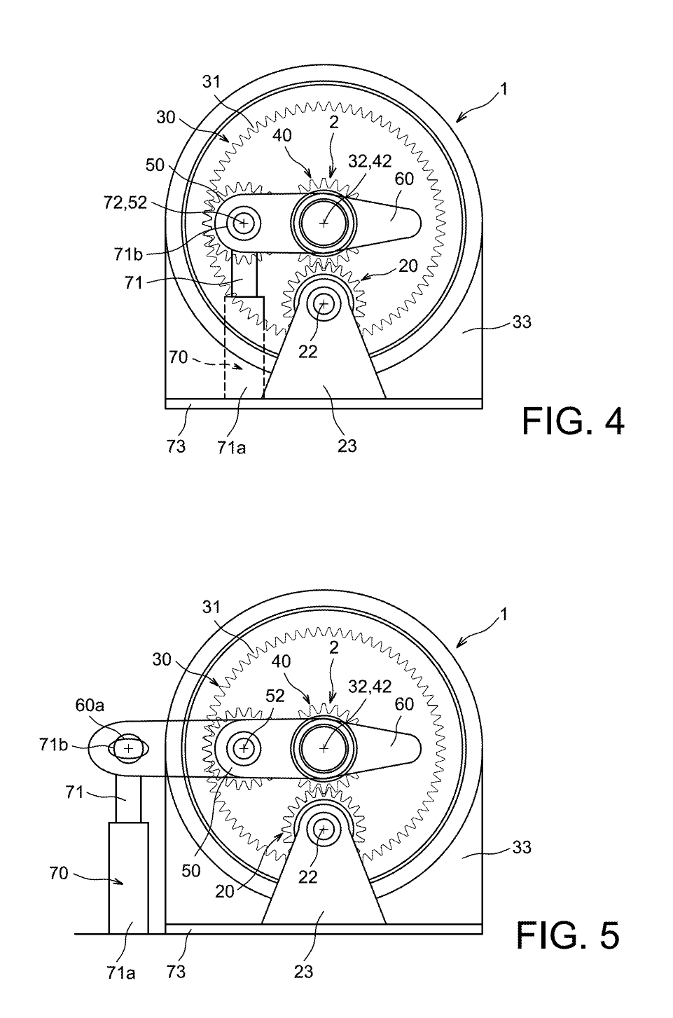

The embodiments in FIGS. 4 and 5 are structurally differentiated from the embodiment in FIG. 3 only by the structure of means 70 of rotating the mobile support, more precisely by the position of the actuator 71 of the means 70 for putting the mobile support 60 in rotation. In this second alternative, the central movement transmission element 40 is supported by the mobile support 60 between the pinion 50 driving the internal gear 30 and the connection zone 60a of the second end 71b of the actuator. As can be seen better in FIG. 5, the connection zone 60a may for example be in the form of an opening cooperating with the second end of the actuator 71b, so that the mobile support 60 can be put into rotation.

In a first case corresponding to the embodiment shown in FIG. 4, the connecting zone 60a is located at the attachment zone of the pinion 50 driving the internal gear 30 to the mobile support 60, for example at a shaft of the pinion 50 driving the internal gear 30. The test device 1 may then be more compact.

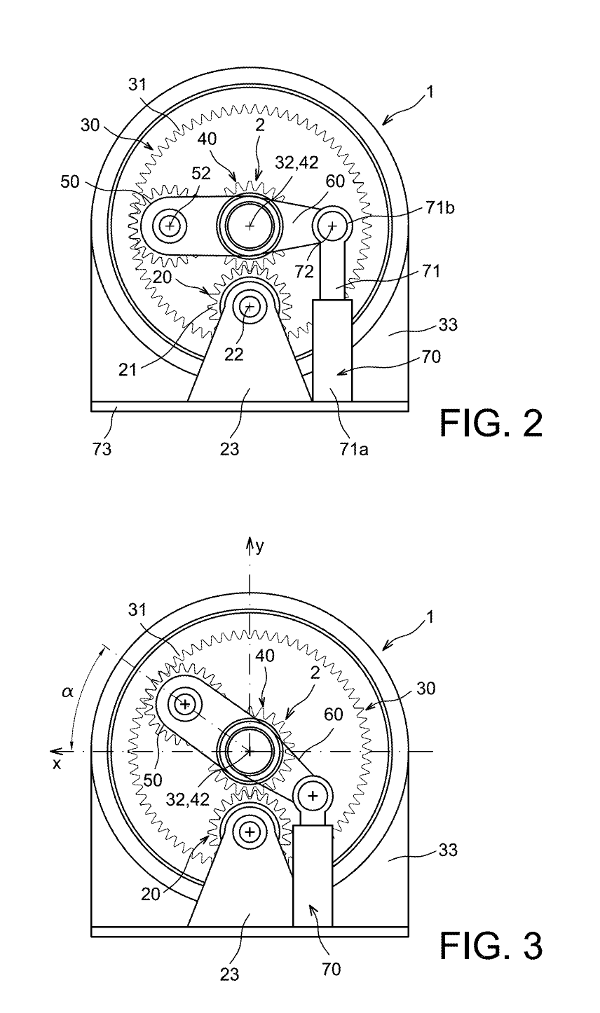

In a second case that corresponds to the embodiment in FIG. 5, the actuator 71 is located outside the periphery of the internal teeth 31 of the internal gear 30. Similarly, it would be possible to envisage a variant (not shown) in FIG. 2 in which the actuator is outside the periphery of the internal teeth 31 of the internal gear 30, on the side opposite the side on which it is shown in FIG. 5.

The maximum torque to be applied to the pinion 20 to be tested can be adapted depending on the position of the actuator 71. The configuration of the actuator 71, particularly the size and required power of the actuator 71 are also variable depending on the position of the actuator. Operation of the mechanical test device 1 of a pinion 20 to be tested in the embodiment shown in FIGS. 4 and 5, and particularly the means for putting the mobile support in rotation 60 under the action of the means 70 for putting the mobile support 60 in rotation and the mechanical test method of the pinion to be tested is identical to that described with reference to FIG. 3, mutatis mutandis. Given that the actuator 71 in the second alternative works in compression when it inclines the mobile support 60 towards the pinion 20 to be tested, the actuator 71 is smaller than it is in the first alternative. In particular, in the embodiment in FIGS. 1 to 3, when the actuator 71 is at its maximum elongation, the pinion 50 driving the internal gear 30 is closest to the pinion 20 to be tested along the periphery of the internal gear 30. In the embodiment shown in FIGS. 4 and 5, the pinion 50 driving the internal gear 30 is closest to the pinion 20 to be tested along the periphery of the internal gear 30 when the actuator 71 is in maximum compression. In the embodiment shown in FIGS. 1 to 3, as the elongation of the actuator 71 increases, the pinion driving the internal gear 30 moves towards the pinion 20 to be tested along the periphery of the internal gear 30. In the embodiment shown in FIGS. 4 and 5, as the compression of the actuator 71 increases, the pinion driving the internal gear 30 moves towards the pinion 20 to be tested along the periphery of the internal gear 30.

What is claimed is:

1-10. (canceled)

11. Mechanical test device of a pinion to be tested comprising:
an internal gear with internal teeth, configured to engage a pinion to be tested, the axis of the internal gear being fixed relative to the axis of the pinion to be tested,
an internal gear support on which the internal gear is installed,
a central movement transmission element, configured to have a rotation movement about a fixed axis fixed relative to the axis of the internal gear provided with internal teeth,
a pinion to drive the internal gear, configured to engage the internal teeth of the internal gear,
a mobile support on which the internal gear drive pinion is fixed,
a support for the pinion to be tested, fixed relative to the internal gear support,
means for putting the mobile support in rotation about the axis of the internal gear, while the assembly composed of the pinion to be tested, the internal gear with its internal teeth, the central transmission element and the pinion driving the internal gear is put into movement.

12. Device according to claim 11, wherein the means for putting the mobile support in rotation include at least one actuator.

13. Device according to claim 11, wherein the actuator comprises a first end and a second end, the first end connecting the actuator to a support fixed relative to the support of the internal gear, the second end connecting the actuator to the mobile support within a connection zone, the central movement transmission element being supported by the mobile support between the internal gear drive pinion and the connection zone.

14. Device according to claim 12, wherein the actuator comprises a first end and a second end, the first end connecting the actuator to a support fixed relative to the support of the internal gear, the second end connecting the actuator to the mobile support in a connection zone, the pinion driving the internal gear being supported by the mobile support between the central movement transmission element and the connection zone.

15. Device according to claim 11, wherein the means for putting the mobile support in rotation are configured to enable displacement of the internal gear drive pinion over a sufficient angular range at the end of the teeth of the outer internal gear so that the required meshing force can be reached

16. Device according to claim 11, wherein the central movement transmission element is a toothed wheel.

17. Device according to claim 11, wherein the internal gear drive pinion is identical to the pinion to be tested.

18. Device according to claim 11, wherein the central movement transmission element and the pinion to be tested, the pinion to be tested and the internal gear, the internal gear and the internal gear drive pinion each form a parallel gear system.

19. Device according to claim 11, wherein the assembly is driven by rotating a movement transmission element chosen from among the pinion to be tested, the internal gear, the central movement transmission element and the internal gear drive pinion.

20. Method for making a mechanical test of a pinion to be tested using a mechanical test device of a pinion to be tested according to claim 11, comprising at least:
a step in which the mobile support is rotated about the axis of the internal gear, step during which the assembly composed of the pinion to be tested, the internal gear with its internal teeth, the central movement transmission element and the internal gear drive pinion is forced into movement.
